(19) United States
(12) Patent Application Publication
(10) Pub. No.: US 2026/0258588 A1
(43) Pub. Date: Sep. 3, 2026

(54) METHOD AND NON-TRANSITORY COMPUTER READABLE MEDIUM

(71) Applicant: Brother Kogyo Kabushiki Kaisha, Nagoya (JP)

(72) Inventor: Yuta Kamihira, Yokkaichi (JP)

(21) Appl. No.: 19/552,004

(22) Filed: Feb. 27, 2026

(30) Foreign Application Priority Data
Feb. 28, 2025 (JP) 2025-032458

(51) Int. Cl. D05C 5/04; G06Q 30/0601

(52) U.S. Cl. CPC D05C 5/04; G06Q 30/0643; D05D 2205/16

(57) ABSTRACT

A method includes receiving, from a first device, application data including embroidery data that causes a sewing machine to sew a pattern, examining the embroidery data; and permitting, after examining the embroidery data, a second device, which is different from the first device, to download the embroidery data via the Internet.

### TECHNICAL FIELD

This application claims priority from Japanese Patent Application No. 2025-032458 filed on February 28, 2025. The entire content of the priority application is incorporated herein by reference.

### BACKGROUND

A method for selling digital content is known in which content uploaded to a server by an applicant can be made publicly available for purchase by other users. The sales method accepts the upload of cut data used by a cutting machine to cut sheet-shaped materials. The method publishes information about the cut data on a webpage. It also accepts purchase requests for the cut data from users who access the webpage. After purchasing, the user downloads the cut data to a cutting machine, which then cuts the material according to the purchased cut data.

### SUMMARY

In conventional platforms, no consideration has been given to allowing users to upload embroidery data—which is different from cut data—so that other users can acquire it.

The purpose of this disclosure is to provide a method and a program that help make embroidery data available for users to acquire.

A method according to one aspect of the present disclosure may include receiving, from a first device, application data including embroidery data that causes a sewing machine to sew a pattern, examining the embroidery data; and permitting, after examining the embroidery data, a second device, which is different from the first device, to download the embroidery data via the Internet.

A non-transitory computer readable medium storing computer-readable instructions that, when executed by one or more of processors according to one aspect of the present disclosure may cause the one or more of the processors to perform receiving, from a first device, application data including embroidery data that causes a sewing machine to sew a pattern, transmitting, to the first device, a result of examining the embroidery data; and permitting, after transmitting the result of examining the embroidery data to the first device, a second device different from the first device to download the embroidery data via the Internet.

A method according to another aspect of the present disclosure may include displaying, at a first device of an applicant, an application screen for uploading selected data that is at least one selected from embroidery data and print data, the embroidery data being data for causing a sewing machine to sew an embroidery pattern, and the print data being data for causing a printer to print a print pattern, accepting upload of the selected data based on the application screen and displaying, at a second device of a user different from the applicant, a publication screen showing the selected data.

A method according to the other aspect of the present disclosure may include generating embroidery data that causes a sewing machine to sew a pattern, transmitting to a server application data including the embroidery data and receiving, from the server, sales information indicating that the embroidery data has been purchased by a user.

### BRIEF DESCRIPTION OF THE DRAWINGS

FIG. 1 is a block diagram illustrating the schematic configuration of a processing-data provision system 7 including a first device 1, a second device 2, a third device 3, and a server 4.

FIG. 2 is a flowchart of a method for providing processing data executed in the processing-data provision system 7.

FIG. 3, including FIGS. 3A and 3B is a timing chart of a method for providing processing data executed in the processing-data provision system 7.

FIG. 4, including FIGS. 4(A) and 4(B), is an explanatory diagram showing transitions of an application screen G1.

FIG. 5, including FIGS. 5(A) and 5(B), is an explanatory diagram showing transitions of a first screen G10.

FIG. 6 is an explanatory diagram of an application screen G20.

FIG. 7 is a flowchart of a processing-data application process and an application-receiving process.

FIG. 8 is a flowchart of an input-updating process.

FIG. 9 is a flowchart of a processing-data evaluation process and an examination process.

FIG. 10 is a flowchart of a processing-data publication process.

FIG. 11, including FIGS. 11(A) to 11(C), is an explanatory diagram of screens displayed on a display 28 of the second device 2.

### DETAIL DESCRIPTION

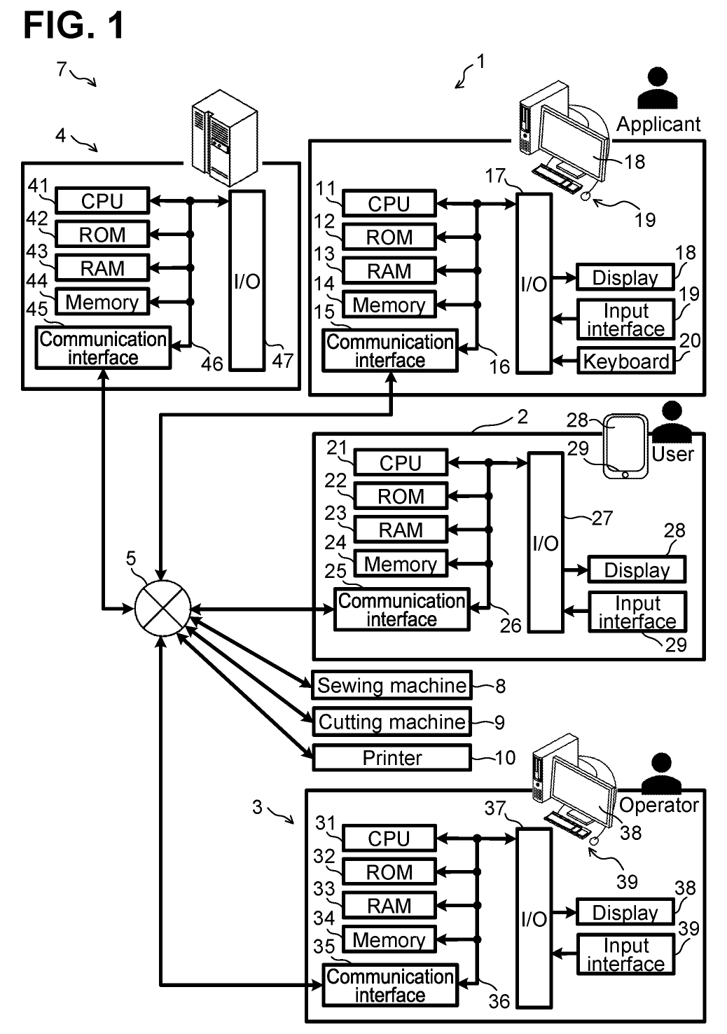

Embodiments of the present disclosure will be described below with reference to the drawings. As shown in FIG. 1, a processing-data provision system 7 (hereinafter, “system 7”) includes a first device 1, a second device 2, a third device 3, and a server 4. The system7 provides a system for selling processing data over the Internet 5. The processing data in the present embodiment includes at least one type selected from embroidery data, cut data, and print data. In this embodiment, the processing data includes at least the embroidery data. More specifically, the processing date in this embodiment may include all three: the embroidery data, cut data, and print data. The server 4 receives, from the first device 1 via the Internet 5, application data including processing data and identification information (ID) of the applicant. For example, the server 4 receives application data including the embroidery data and the applicant’s ID. Upon receiving the application data from the first device 1, the server 4 stores the application data in a memory 44 of the server 4, which will be described later.

An operator examines whether the processing data meets predetermined criteria. Specifically, the operator uses the third device 3 to examine the processing data stored as application data in the memory 44 of the server 4. The examination may be performed manually by the operator, or may be automatically executed by the third device 3 used by the operator. The examination determines whether the embroidery data should be made accessible to the second device 2. The third device 3 transmits to the server 4 the result of examining whether the processing data meets the predetermined criteria. When the operator determines that the processing data satisfies the criteria, the operator causes the server 4 to publish the processing-data information on the Internet 5. As a result, the second device can acquire the processing data from the server 4 via the Internet 5.

The server 4 receives a request for acquiring the processing data from the second device 2. If the second device 2 satisfies the acquisition requirements, the server 4 permits the second device 2 to download the processing data.

The second device 2 transmits the processing data downloaded from the server 4 to a processing machine. The processing machine is one of a sewing machine 8, a cutting machine 9, or a printer 10. When the processing data is the embroidery data, the second device 2 transmits the embroidery data to the sewing machine 8. The sewing machine 8 is capable of performing embroidery sewing based on the embroidery data received via the Internet 5.

When the processing data is cut data, the second device 2 transmits the cut data to the cutting machine 9. The cutting machine 9 is configured to perform cutting of sheet-shaped media according to cut data received via the Internet 5.

When the processing data is print data, the second device 2 transmits the print data to the printer 10. The printer 10 is configured to print an image onto a medium according to print data received via the Internet 5.

Next, the electrical configurations of the first device 1, the second device 2, the third device 3, and the server 4 of the system 7 will be described in this order. In the following description, the embroidery data will be used as an example of processing data. The processing data may be any of the three types: the embroidery data, cut data, or print data.

The first device 1 is a device capable of communicating with the server 4. The first device 1 is a PC (personal computer) used by the applicant. The applicant is a person who, for example, creates embroidery data and applies to the server 4 to publish the embroidery data over the Internet 5. The applicant generates the embroidery data using embroidery-data generation software installed on the first device 1. The applicant accesses a dedicated application webpage (application page) using the first device 1. Through the application page, the applicant sends application data including the embroidery data and the applicant’s ID to the server 4 to apply for publication of the embroidery data on the Internet 5.

The first device 1 includes a CPU (Central Processing Unit) 11, a ROM (Read Only Memory) 12, a RAM (Random Access Memory) 13, a memory 14, a communication interface 15, an input/output interface 17, a display 18, and an input interface 19. The communication interface 15 is referred to as “communication IF 15,” the input/output interface 17 as “I/O 17,” and the input interface 19 as “input IF 19.

The CPU 11 is electrically connected to the ROM 12, the RAM 13, the memory 14, the communication IF 15, and the I/O 17 via a bus 16. The CPU 11 controls the first device 1. The ROM 12 stores boot programs and BIOS. The RAM 13 stores temporary data.

The communication IF 15 is an interface for connecting the first device 1 to the Internet 5. Through the communication IF 15, the CPU 11 can transmit and receive data with other devices connected to the Internet 5, including the server 4. The I/O 17 is connected to the display 18 and the input IF 19. The display 18 is capable of displaying images and may be, for example, a liquid-crystal display. The input IF 19 may be a mouse or keyboard and is used to input various information.

The second device 2 is, for example, a smartphone used by a user. A user is a person who purchases embroidery data published on the Internet 5 and causes a sewing machine 8 to sew an embroidery pattern. Specifically, the user accesses a dedicated publication webpage (publication page) via a web browser on the second device 2 to browse and purchase embroidery data. The user operates the second device 2 to transmit purchased embroidery data from the second device 2 to the sewing machine 8. The sewing machine 8 performs embroidery sewing based on the received embroidery data.

The second device 2 includes a CPU 21, ROM 22, RAM 23, a memory 24, a communication interface 25, an input/output interface 27, a display 28, and an input interface 29. The communication interface 25 is referred to as “communication IF 25,” the input/output interface 27 as “I/O 27,” and the input interface 29 as “input IF 29.”

The CPU 21 controls the second device 2. Via a bus 26, the CPU 21 is electrically connected to the ROM 22, RAM 23, memory 24, communication IF 25, I/O 27, display 28, and input IF 29. The ROM 22 stores programs and various settings. The RAM 23 stores temporary data. The memory 24 is a nonvolatile storage device and stores various settings necessary for executing main processes.

The communication IF 25 is an interface for connecting the second device 2 to the Internet 5. Through the communication IF 25, the CPU 21 can transmit and receive data with other devices connected to the Internet 5, such as the sewing machine 8, the cutting machine 9, the printer 10, and the server 4. The I/O 27 is connected to the display 28 and the input IF 29. The display 28 may be, for example, a liquid-crystal display. The input IF 29 may be a touch panel and is used to input various commands.

The third device 3 is a device capable of communicating with the server 4. The third device 3 is a PC used by the operator. The operator is one or more individuals responsible for managing and operating the system 7. The operator examines the embroidery data and permits publication of the embroidery data on the Internet 5 via the server 4. The operator accesses a dedicated management webpage (management page) through the third device 3 and receives the embroidery data. The server 4 stores the management page in the memory 44. The operator examines the embroidery data. The operator accesses the management page using the third device 3, enters an examination result, and permits publication of the embroidery data on the Internet 5.

The phrase “the operator examines the embroidery data” includes cases where, under the operator’s instruction, a third party or a device such as the third device 3 determines whether the embroidery data meets predetermined criteria. Thus, “the operator examines the embroidery data” is not limited to the operator directly performing the examination.

The third device 3 includes a CPU 31, a ROM 32, a RAM 33, a memory 34, a communication IF 35, an input/output interface 37, a display 38, and an input interface 39. The communication IF 35 is referred to as “communication IF 35,” the input/output interface 37 as “I/O 37,” and the input interface 39 as “input IF 39.”

The CPU 31 is electrically connected to the ROM 32, RAM 33, memory 34, communication IF 35, and I/O 37 via a bus 36. The CPU 31 controls the third device 3. The ROM 32 stores boot programs and BIOS. The RAM 33 stores temporary data.

The communication IF 35 is an interface for connecting the third device 3 to the Internet 5. Through the communication IF 35, the CPU 31 can transmit and receive data with other devices connected to the Internet 5, including the server 4. The I/O 37 is connected to the display 38 and input IF 39. The display 38 is capable of displaying images and may be a liquid-crystal display. The input IF 39 may be a mouse or keyboard and is used to input various information.

The server 4 is a device capable of communicating with the first device 1, the second device 2, and the third device 3. The server 4 is a web server that receives application data including embroidery data and publishes embroidery data on the Internet 5. The server 4 includes a CPU 41, ROM 42, RAM 43, a memory 44, a communication interface 45, and an input/output interface 47. The communication interface 45 is referred to as “communication IF 45,” and the input/output interface 47 as “I/O 47.

The CPU 41 is electrically connected to the ROM 42, RAM 43, memory 44, communication IF 45, and I/O 47 via a bus 46. The CPU 41 controls the server 4. The ROM 42 stores various programs. The RAM 43 stores temporary data. The communication IF 45 is an interface for connecting the server 4 to the Internet 5. Through the communication IF 45, the CPU 41 can transmit and receive data with other devices connected to the Internet 5.

The server 4 stores an application page, a publication page, and a management page. The server 4 stores the application page, the publication page, and the management page as separate data. The application page, publication page, and management page are webpages created in, for example, HTML format. The devices that access these pages and their purposes differ. The application page is accessed by the first device 1. The first device 1 accesses the application page to send application data including processing data.

The publication page is a page accessible by the second device 2. The second device 2 accesses the publication page to display processing data. The user browses or purchases processing data through the publication page. The management page is a page accessible by the third device 3 used by the operator who operates the system 7. Each of the application page, publication page, and management page may consist of a single page or multiple pages. The server 4 of this embodiment assigns a unique application page for each applicant. The unique application page for each applicant is managed using, for example, the applicant’s identification information.

Any appropriate method may be used to manage the application page, publication page, and management page separately. For both the application page and the management page, universal links or application links—links usable by both web and application—may be assigned as follows. The operator assigns a unique domain to each of the application page, publication page, and management page. The server 4 may separate folders by domain using virtual-host settings. The server 4 performs authentication processing for the application page so that only the first device 1, used by an applicant with access privileges, can access the page. The server 4 performs authentication processing for the management page so that only the third device 3, used by an operator with access privileges, can access the page.

In this specification, transmitting data from the server 4 to another device for displaying various pages means transmitting to another device the information to be displayed on its display based on the transmitted data. Receiving data from the server 4 for displaying various pages means that another device receives, from the server 4, information that will be displayed on its display based on the received data.

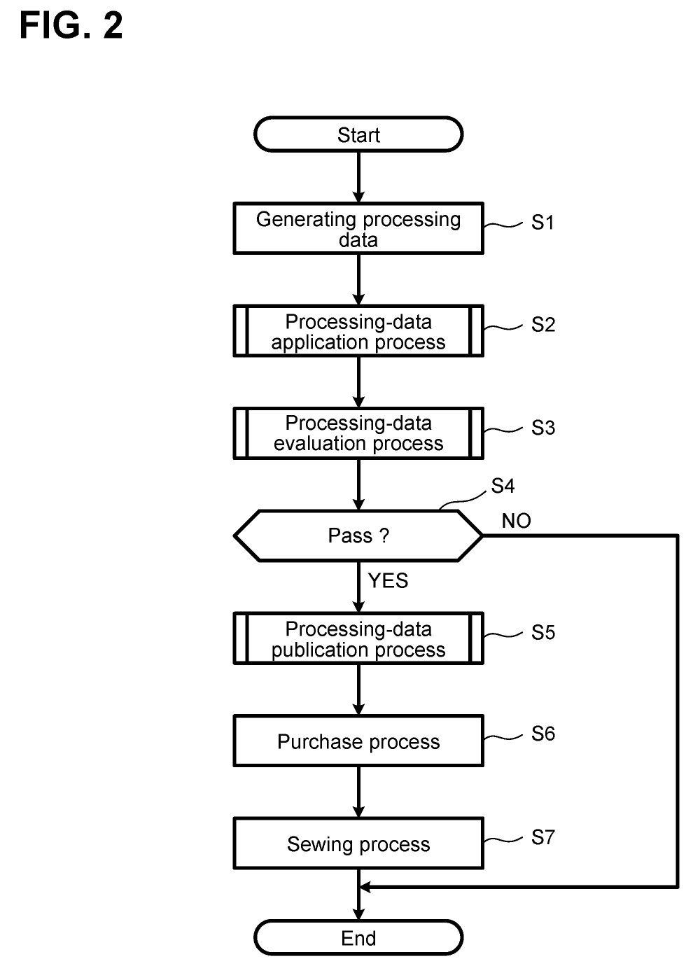

A method executed in the system 7 will now be described with reference to FIGS. 2 to 13. The method relates to a technique in which a user acquires, from the server 4 using the second device 2, processing data that has been transmitted to the server 4 by an applicant using the first device 1. The method is executed using the first device 1, the second device 2, the third device 3, and the server 4. As a specific example, the case where the processing data is the embroidery data will be described.

As shown in FIG. 2, the first device 1 of the applicant generates processing data (S1). The step in which the applicant generates processing data using the first device 1 is the generation step. The processing data may be generated by any known method. Specifically, the first device 1 may launch embroidery-data generation software and generate the embroidery data according to the following procedure. The first device 1 accepts input of image data representing an illustration of a flower, entered by the applicant using the input IF 19. Based on the image data, the first device 1 designates stitch points (needle-drop points) for each color region in the illustration and defines the stitching order connecting these points. The first device 1 generates the embroidery data that includes stitching order, coordinate data of the needle-drop points, and thread-color data.

The embroidery data is data for causing the sewing machine 8 to sew an embroidery pattern. A needle-drop point is a point at which the needle attached to the lower end of the needle bar of the sewing machine 8 descends and penetrates the workpiece held in an embroidery frame. The coordinate data of the needle-drop points is represented by XY coordinates indicating the relative position of the embroidery frame with respect to the needle bar, using a predetermined point as an origin. The origin may be set as appropriate; for example, the position where the horizontal center of the embroidery frame lies below the needle bar. The coordinate data of the needle-drop points may be replaced with other data indicating the needle-drop points. The coordinate data may also represent movement amounts of the embroidery frame in the XY directions. The stitching order indicates the order in which the needle is lowered at the needle-drop points according to the coordinate data. For example, the order in which coordinate data is stored may serve as the stitching order. The embroidery data may include at least data indicating the needle-drop points The embroidery data may further include thread-color data.

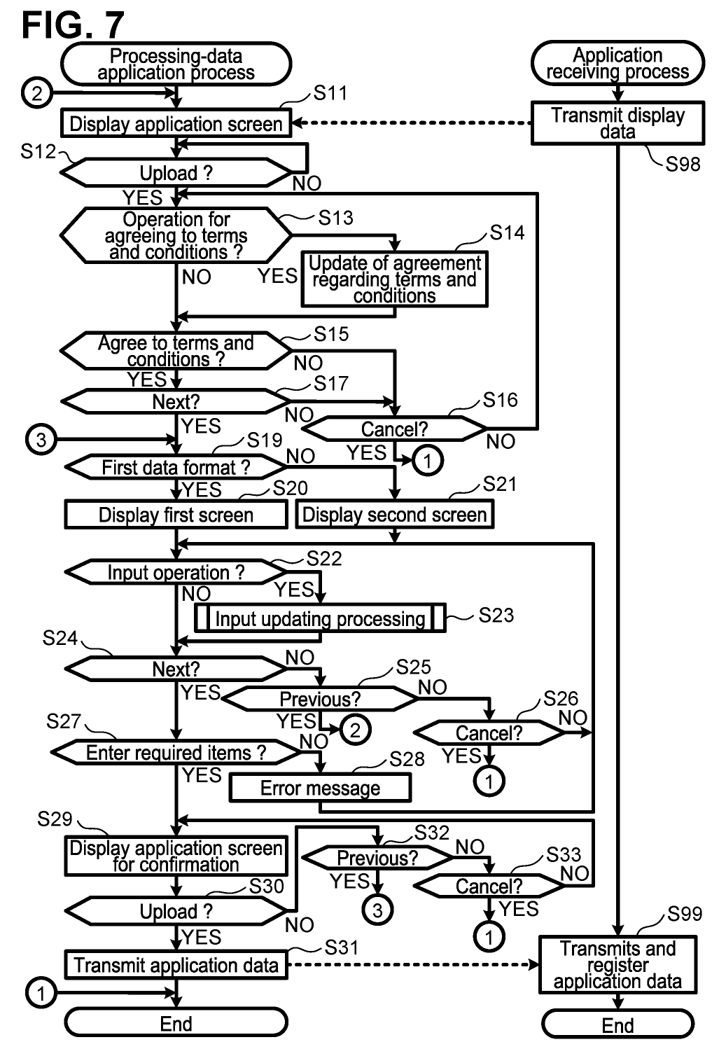

When the first device 1 detects, by operation of the input IF 19, an instruction to access the application page, the first device 1 accesses the application page. The first device 1 performs processing to establish a communication connection, such as a handshake, with the server 4 managing the application page. Once communication is established, the first device 1 executes the processing-data application process shown in FIG. 7 according to a program stored in the ROM 12 (S2).

The CPU 11 executes the following steps according to instructions in the program read into the RAM 13. The first device 1 either receives from the server 4 or stores in the memory 14 various parameters necessary for executing the processing-data application process. The first device 1 stores various data acquired during the processing-data application process as appropriate.

The CPU 41 of the server 4 executes the following steps according to a program stored in the ROM 42, in response to the first device 1 accessing the server 4, so as to execute the application-receiving process shown in FIG. 7. The first device stores in the memory 44 various parameters necessary for executing the application-receiving process. The first device 1 stores various data acquired during execution of the application-receiving process in the memory 44 as appropriate.

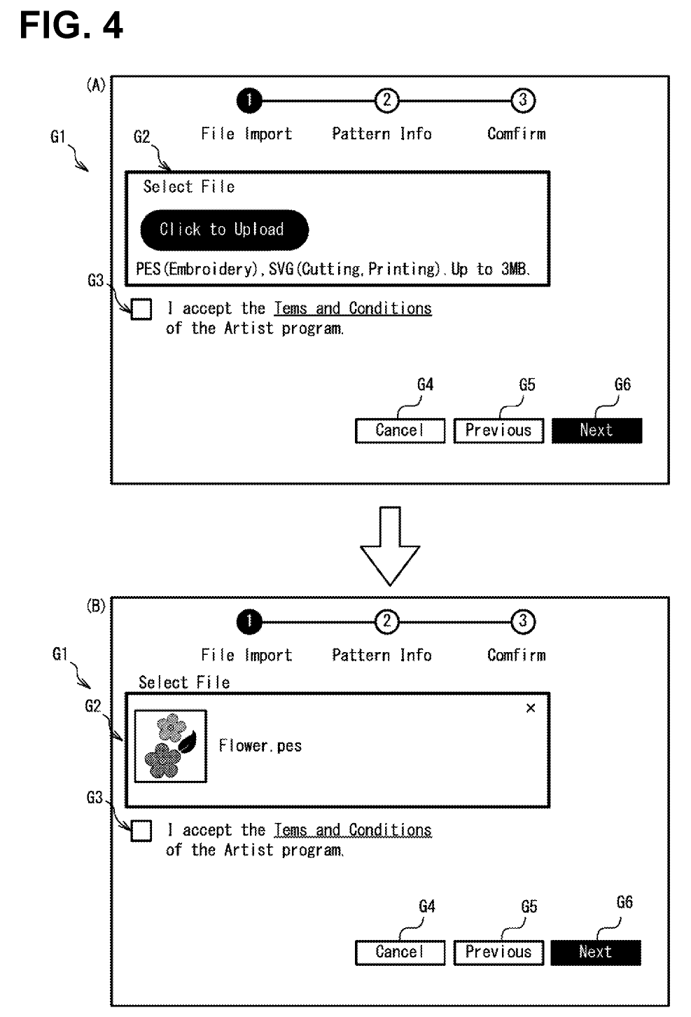

As shown in FIG. 7, when communication between the first device 1 and the server 4 is established, the CPU 41 of the server 4 transmits display data to the first device 1 (S98). The display data is data for displaying, on the display 18 of the first device 1, the application screens shown in FIGS. 4(A) to 6. The display data may be transmitted all at once at step S98 or transmitted in multiple portions according to the progress of processing on the first device 1.

The CPU 11 of the first device 1 receives the display data from the server 4 and displays an application screen G1 on the display 18 based on the received data (S11). The application screen G1 is a screen for uploading selected data, which is at least one data selected from embroidery data, cut data, and print data.

As shown in FIG. 4(A), the application screen G1 includes a field G2, a checkbox G3, and key images G4 to G6. By operating the field G2 using the input IF 19, the applicant uploads the selected data to the server 4. The checkbox G3 is used to indicate whether the applicant agrees to the terms and conditions defined by the operator. When the checkbox G3 is checked, the CPU 11 determines that the applicant agrees to the terms. When the checkbox G3 is unchecked, the CPU 11 determines that the applicant does not agree. The initial state of the checkbox G3 is unchecked.

The key image G4 is selected when an instruction is input to display the previous page. The previous page is, for example, a page that inputs the instruction to display the application screen G1. The key image G5 is selected when canceling the processing-data application process. The key image G6 is selected when an instruction is input to display the next page.

The CPU 11 determines whether processing data has been uploaded to the server 4 from the field G2 (S12). The first device 1 can upload at least one of the three types of processing data—embroidery, cut, or print—from the field G2. In the specific example, the applicant selects embroidery data stored in the memory 14 as selected data, and the first device 1 uploads the selected embroidery data to the server 4. When the CPU 11 determines that the processing data has not been uploaded (S12: NO), the CPU 11 waits at step S12. When the CPU 11 determines that the processing data has been uploaded (S12: YES), the CPU 11 updates the application screen G1 as shown in FIG. 4(B).

In the field G2 of the application screen G1 shown in FIG. 4(B), the file name and the thumbnail image of the processing data uploaded to the server 4 are displayed. The CPU 11 may generate a thumbnail image based on the processing data and display the thumbnail image in the field G2. In the specific example, the CPU 11 acquires the thumbnail image from the server 4. The CPU 41 of the server 4 analyzes the embroidery data, identifies the coordinates of line segments based on the needle-drop coordinate data for each thread color, and draws the line segments on a virtual canvas in the corresponding colors. The CPU 41 generates an image file in an appropriate format, resizes the image to a thumbnail size, and transmits the thumbnail-image data to the first device 1. The CPU 11 may display an image represented by image data included in the processing data as the thumbnail image.

The CPU 11 determines whether selection of the checkbox G3 is detected based on the output of the input IF 19 (S13). When selection of the checkbox G3 is detected (S13: YES), the CPU 11 updates the value of the checkbox G3 (S14). When the checkbox is unchecked and the checkbox G3 is operated, the CPU 11 checks the checkbox G3. When the checkbox is checked and the checkbox G3 is operated, the CPU 11 unchecks the checkbox G3.

When the CPU 11 determines that the checkbox G3 has not been selected (S13: NO), or after the processing in step S14, the CPU 11 executes step S15. The CPU 11 determines whether the applicant agrees to the terms based on the checkbox G3 (S15). When the CPU 11 determines that the applicant does not agree to the terms (S15: NO), the CPU 11 determines whether the key image G4 has been selected (S16). When the key image G4 has been selected (S16: YES), the processing-data application process ends. When the key image G4 has not been selected (S16: NO), processing returns to step S13. Thus, when the applicant does not agree to the terms (S15: NO), the CPU 11 does not accept selection of the key image G6.

When the CPU 11 determines that the applicant agrees to the terms (S15: YES), the CPU 11 executes step S17. The CPU 11 determines whether selection of the key image G6 is detected based on the input IF 19 (S17). When selection of key image G6 is not detected (S17: NO), the CPU 11 executes step S16.

When the CPU 11 determines that the key image G6 has been selected (S17: YES), the CPU 11 executes step S19. The CPU 11 determines whether the file format of the selected data uploaded in S12 is a first data format (S19). The first data format in this embodiment is a data format specific to embroidery data, specifically the PES format. The CPU 11 determines the file format based on the extension of the selected data.

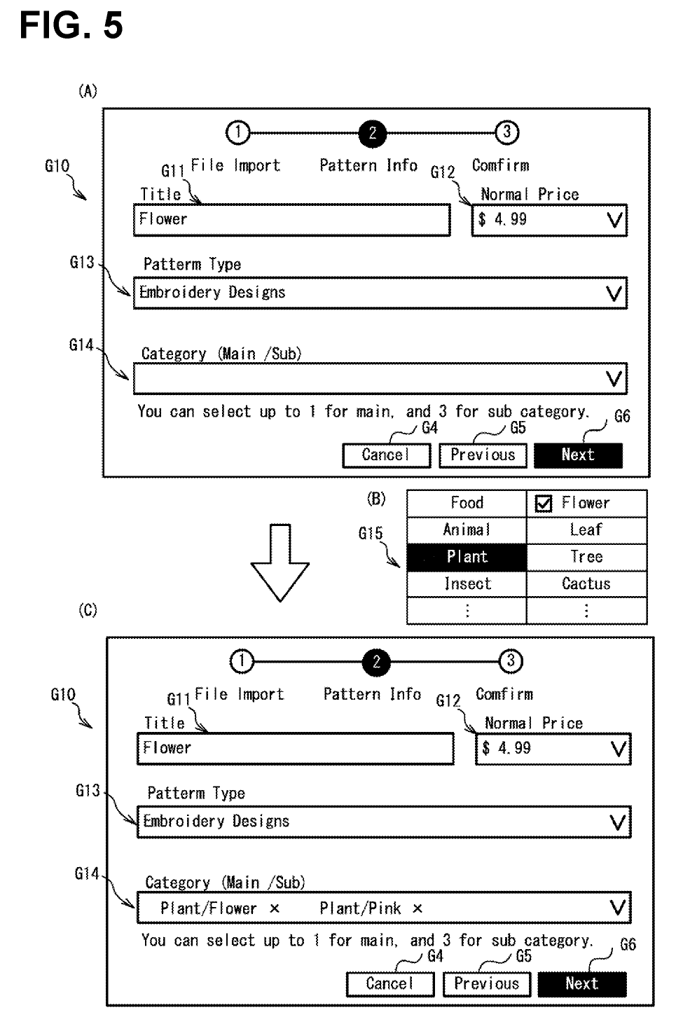

When the CPU 11 determines that the file format is the first data format (S19: YES), the CPU 11 executes step S20. The CPU 11 displays a first screen G10 on the display 18 as shown in FIG. 5(A) (S20). The first screen G10 is displayed when the file format is the first data format.

As shown in FIG. 5(A), the first screen G10 includes fields G11 to G14 and key images G4 to G6. The field G11 is for entering the title of the processing data. The field G12 is for entering the sales price of the processing data. The value of field G12 may be preset or input by the applicant. An example of the initial value of field G12 is USD 4.99. The field G13 indicates the type of processing data. On the first screen G10, embroidery design is selectable in field G13, while cut design and print design are not selectable.

The field G14 indicates the category of the pattern represented by the processing data. The category in this embodiment classifies the subject of the pattern. The category includes a main category and a subcategory associated with the main category. The subcategory further subdivides items categorized under the main category. For example, main categories include Food, Animal, Plant, and Insect. When the main category is Plant, subcategories include Flower, Leaf, Tree, and Cactus. A subcategory is selectable when the main category is selected and is not selectable when the main category is not selected.

The key images G4 to G6 function identically to those on the application screen G1. The applicant operates the input IF 19 to enter values in fields G11 to G14. The items in fields G11 to G14 are required entries. When any required item is not entered, the CPU 11 does not accept the instruction to move to the next page. When the CPU 11 determines that the file format of the uploaded data is not the first data format (S19: NO), the CPU 11 executes step S21. The CPU 11 displays a second screen on the display 18 (S21). The second screen is displayed when the file format is a second data format different from the first data format. Like the first screen, the second screen includes fields G11 to G14 and key images G4 to G6. On the second screen, cut design and print design are selectable in field G13, while embroidery design is not selectable. In this embodiment, the data format of cut data and print data is SVG. Because cut data and print data share the same format, the CPU 11 cannot determine which type is selected solely from the extension, and therefore accepts the applicant’s selection of the type.

After step S20 or S21, the CPU 11 determines whether any input operation has been detected in one of fields G11 to G14 based on the input IF 19 (S22). When an input operation is detected (S22: YES), the CPU 11 performs input updating processing (S23).

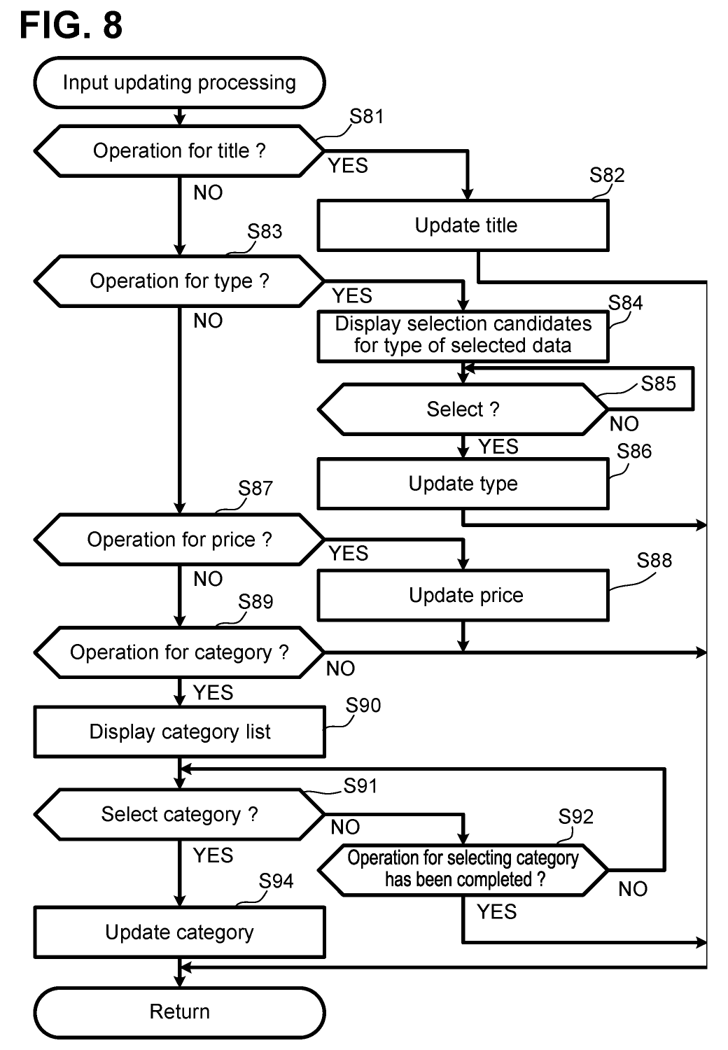

As shown in FIG. 8, in the input updating processing, the CPU 11 determines whether an operation in field G11 has been detected (S81) based on the input IF 19. When an operation in field G11 is detected (S81: YES), the CPU 11 updates the title in field G11 (S82). When no operation in field G11 is detected (S81: NO), the CPU 11 determines whether an operation in field G13 has been detected (S83).

When an operation in field G13 is detected (S83: YES), the CPU 11 displays the selection candidates for the type of selected data (S84). On the first screen G10 (S20), the only available candidate is “Embroidery design.” On the second screen (S21), the candidates are “Cut design” and “Print design.”

The CPU 11 determines whether selection of one of the candidates displayed in step S84 has been detected (S85). The CPU 11 accepts selection of the type from among embroidery design, cut design, and print design (S85). Step S85 is the type-selection step. The type-selection step includes accepting selection of the type based on the file format (S84, S85). Specifically, when the CPU 11 determines that the file format is the first data format (S19: YES), it enables selection of embroidery design (S20, S84). When the file format is the second data format (S19: NO), it enables selection of cut design and print design (S21, S84).

When the CPU 11 determines that the type selection has not been detected (S85: NO), the CPU 11 waits at S85. When the type selection is detected (S85: YES), the CPU 11 updates the type in field G13 based on the detected result (S86).

When no operation in field G13 is detected (S83: NO), the CPU 11 proceeds to step S87. The CPU 11 determines whether an operation in field G12 has been detected (S87). When the CPU 11 determines that an operation in field G12 has been detected (S87: YES), the CPU 11 updates the price in field G12 (S88).

When no operation in field G12 is detected (S87: NO), the CPU 11 proceeds to step S89. The CPU 11 determines whether an operation in field G14 has been detected (S89). When no operation in field G14 is detected (S89: NO), the input-updating processing ends and returns to the processing-data application process. When an operation in field G14 is detected (S89: YES), the CPU 11 displays a category list G15 in field G14 (S90). The category list G15 is included in the display data transmitted by the server 4 in step S98 and stored in the memory 14.

As shown in FIG. 5(B), the category list G15 includes main categories and subcategories. The subcategories are displayed in the right column corresponding to the selected main category. The subcategories become selectable when a main category is selected.

In the category list G15, “Plant” is selected as the main category. The selected main category is displayed differently from unselected categories. In this embodiment, the selected main category is displayed with a black background and white text, while unselected main categories are displayed with a white background and black text.

In the category list G15, “Flower” is selected as the subcategory. A check mark is displayed to the left of the selected subcategory. The applicant selects a desired main category and subcategory from the displayed category list G15 using the input IF 19.

The CPU 11 determines whether a category selection has been detected based on the output of the input IF 19 (S91). The CPU 11 accepts selection of a category for the selected data (S91). When no category selection is detected (S91: NO), the CPU 11 determines whether the operation for selecting a category has been completed (S92). The CPU 11 determines that category selection has been completed when an input to a location other than field G14 is detected.

When the CPU 11 determines that category selection has not been completed (S92: NO), processing returns to step S91. When the CPU 11 determines that category selection has been completed (S92: YES), the input-updating processing ends and returns to the processing-data application process. When the CPU 11 determines that a category has been selected (S91: YES), the CPU 11 updates field G14 based on the selected category (S94). After steps S82, S86, S88, or S94, the CPU 11 ends the input-updating processing and returns to the processing-data application process.

When the CPU 11 determines that no input operation has been detected (S22: NO), or after the processing in step S23, the CPU 11 executes step S24. The CPU 11 determines whether selection of the key image G6 has been detected based on the output of the input IF 19 (S24). When selection of the key image G6 is not detected (S24: NO), the CPU 11 proceeds to step S25. The CPU 11 determines whether the key image G5 has been selected (S25). When the key image G5 is selected (S25: YES), processing returns to step S11.

When the CPU 11 determines that the key image G5 has not been selected (S25: NO), the CPU 11 proceeds to step S26. The CPU 11 determines whether key image G4 has been selected (S26). When key image G4 is selected (S26: YES), the processing-data application process ends. When key image G4 is not selected (S26: NO), processing returns to step S22.

When the CPU 11 determines that the key image G6 has been selected (S24: YES), the CPU 11 determines whether all required items have been entered (S27). When the CPU 11 determines that any of the fields G11 to G14 is blank (S27: NO), the CPU 11 displays an error message on the display 18 (S28) and returns to step S22. An example of the error message is “Please fill in all required items.”

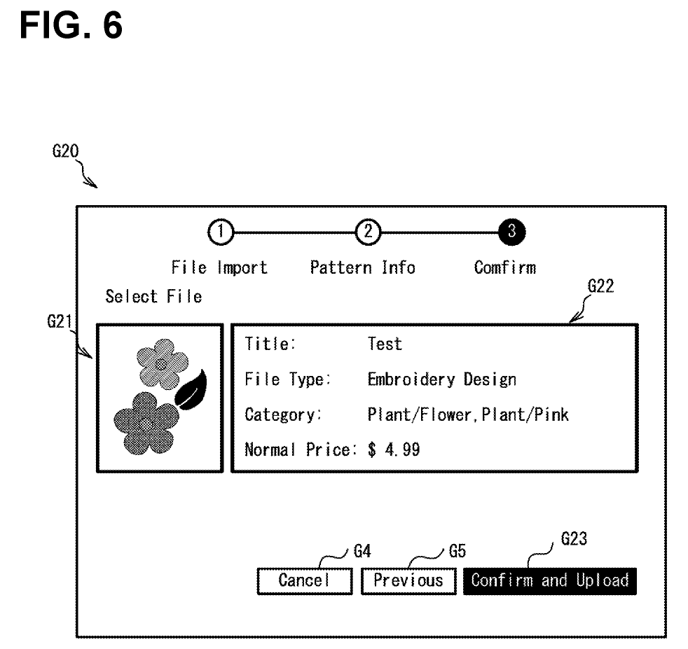

As shown in FIG. 5(C), when the CPU 11 determines that all required fields G11 to G14 have been filled in (S27: YES), the CPU 11 executes step S29. The CPU 11 displays an application screen G20 for confirming the application contents, as shown in FIG. 6 (S29).

As shown in FIG. 6, the application screen G20 includes fields G21 and G22, and key images G4, G5, and G23. The field G21 displays the thumbnail image of the processing data uploaded in step S12. The field G22 displays the contents of the required items set on the first screen G10 or the second screen. The key images G4 and G5 function the same as those on the application screen G1.

The key image G23 is selected when registering, in the memory 44 of the server 4, the processing data uploaded in step S12 together with the contents displayed in field G22. Until the key image G23 is selected, although the processing data has been uploaded to the server 4, the process of registering the application data as examination-target data has not been completed, and the data remains temporarily registered on the server 4. The applicant checks the thumbnail image and the required-item contents displayed on the application screen G20 and selects the key image G23.

The CPU 11 determines whether selection of the key image G23 has been detected based on the output of the input IF 19 (S30). If selection of key image G23 is not detected (S30: NO), the CPU 11 determines whether key image G5 has been selected (S32). When key image G5 has been selected (S32: YES), processing returns to step S19.

When key image G5 has not been selected (S32: NO), the CPU 11 determines whether key image G4 has been selected (S33). When key image G4 has been selected (S33: YES), the processing-data application process ends. When key image G4 has not been selected (S33: NO), processing returns to step S29.

When the CPU 11 determines that the key image G23 has been selected (S30: YES), the CPU 11 executes the application step of transmitting the application data—including the embroidery data—to the server 4 (S31). The application data includes the processing data, the application contents acquired through the application screens, and the applicant’s identification information (ID). The CPU 11 transmits the application data to the server 4 in a secure manner, for example, via encrypted communication such as SSL (Secure Sockets Layer). The application data is transmitted from the first device 1 to the server 4 in a state inaccessible by the second device 2.

The “state inaccessible by the second device 2” is achieved, for example, by restricting access to the application page to the applicant and by securing the communication through encryption. In this embodiment, the server 4 restricts access to the application page by requiring applicant authentication using the applicant’s ID and password at login. The server 4 may also notify access-address information for the application page only to the applicant, ensuring that the second device 2 cannot access it. The CPU 11 then ends the processing-data application process.

The CPU 41 of the server 4 receives the application data from the first device 1. In the specific example, the CPU 41 receives application data from the first device 1 of an applicant (who is different from the operator) through the application page published on the server 4 (S99). The application data includes at least the embroidery data that causes the sewing machine 8 to sew a pattern. The CPU 41 accepts upload of the selected data through the application page in process S99, then ends the application-receiving process.

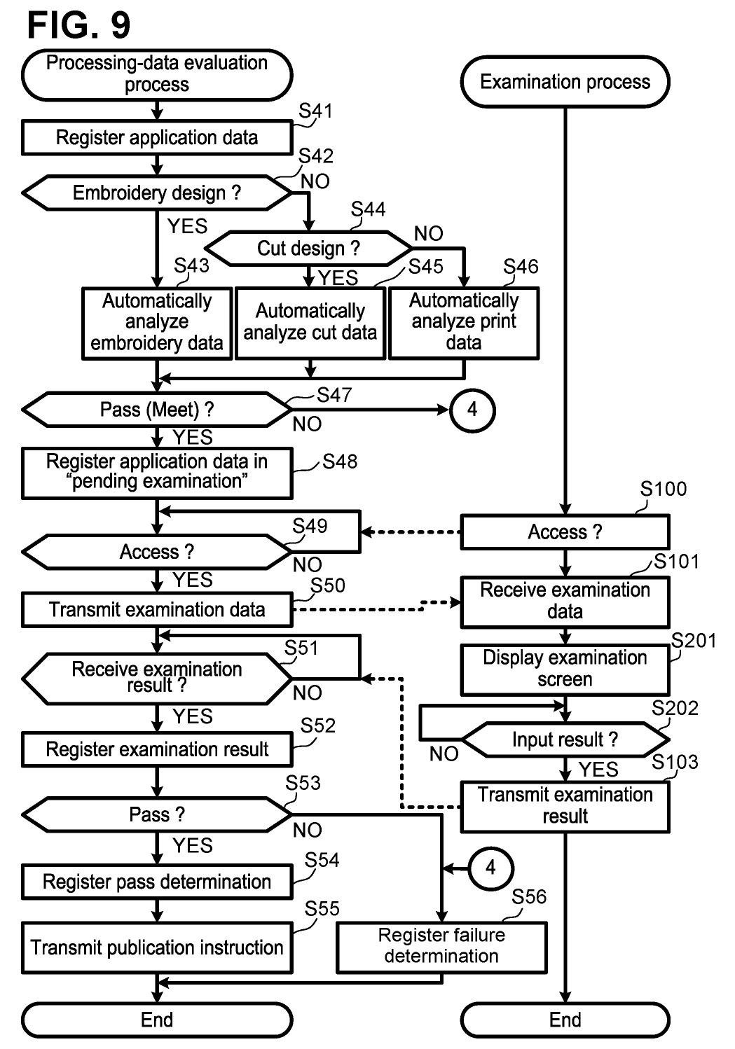

As shown in FIG. 2, the CPU 41 of the server 4 executes a processing-data evaluation process (S3). When the server CPU 41 receives application data from the first device 1, the CPU 41 executes the processing-data evaluation process shown in FIG. 9 by following instructions in a program stored in the ROM 42. Various parameters necessary for executing the processing-data evaluation process are stored in the memory 44, and data acquired during the process is also stored as needed.

As shown in FIG. 9, the CPU 41 registers the application data received from the first device 1 into the management page, which is different from the application page (S41). “Registering in the management page” means storing the data in the server 4 in association with the management page. Before step S41, the operator cannot view information included in the application data through the management page. After step S41, the operator can view such information. The CPU 41 determines whether the type of selected data in the application data is an embroidery design (S42). When the selected data is an embroidery design (S42: YES), the CPU 41 automatically analyzes whether the embroidery data in the application data meets predetermined criteria (S43).

The predetermined criteria are defined by the operator, who is different from the applicant. The criteria are set considering safety and finished quality when the processing machine performs processing based on the processing data. When the processing data is embroidery data, the predetermined criteria may include a first criterion. The first criterion may specify, for example, that the number of needle-drop points set at a specific point does not reach or exceed a first threshold. This prevents excessive perforation that could result in holes in the sewn material.

When the selected data is not an embroidery design (S42: NO), the CPU 41 determines whether it is a cut design (S44). When it is a cut design (S44: YES), the CPU 41 automatically analyzes whether the cut data meets predetermined criteria (S45). The predetermined criteria for cut data may include a second criterion. The second criterion may specify, for example, that no part of the cutting pattern has a width below a second threshold. This reduces the possibility that narrow portions may tear and prevent proper cutting of the intended shape.

When the selected data is not a cut design (S44: NO), the CPU 41 automatically analyzes whether the print data meets predetermined criteria (S46). For print data, the predetermined criteria may include a third criterion. The third criterion may specify, for example, that the size of the printed pattern does not exceed the size of the media. This reduces the possibility that the printed pattern extends beyond the paper.

After step S43, S45, or S46, the CPU 41 determines whether the analysis result meets the predetermined criteria (S47). When the analysis result does not meet the criteria (S47: NO), without operator examination the CPU 41 registers information indicating a failure determination in the memory 44 (S56). In this case, the CPU 41 does not publish the processing data or related information included in the application data.

When the analysis result meets the predetermined criteria (S47: YES), the CPU 41 registers the application data in a “pending examination” section of the management page (S48). This section lists application data awaiting operator examination, in the order registered. The CPU 41 then determines whether the third device 3, used by the operator, has accessed the management page (S49). When the CPU 41 determines that the third device 3, used by the operator, has not accessed the management page (S49: NO), the CPU 41 waits.

When the operator begins examination, they input a start-instruction using the input IF 39 of the third device 3. The CPU 31 of the third device 3 executes the examination process shown in FIG. 9 based on instructions in a program stored in the ROM 32. The third device 3 stores parameters necessary for executing the examination process in the memory 34, and stores data acquired during the examination as needed.

The CPU 31 of the third device 3 accesses the management page stored in the memory 44 of the server 4 (S100). The third device 3 performs a handshake or similar communication process with the server 4 to establish a connection.

When communication with the third device 3 is established (S49: YES), the CPU 41 of the server 4 transmits examination data to the third device 3 (S50). The examination data includes data for displaying an examination screen on the display 38 of the third device 3 and the processing data contained in the application data that is pending examination.

When the CPU 31 of the third device 3 receives the examination data (S101), the CPU 31 displays the examination screen on the display 38 based on the received data (S201). The examination screen includes an input field for entering the examination result and a key image for instructing transmission of the entered examination result to the server 4. Based on the processing data received in S101, the operator performs the examination step using the third device 3 (S102). The operator accesses the management page — which differs from the application and publication pages — and examines whether the processing data satisfies predetermined criteria. Step S102 is the examination step. In this embodiment, the examination includes judging whether embroidery data may be made accessible to the second device 2.

The predetermined criteria of step S102 are defined by the operator for each type of processing data, from a different viewpoint than the automated analysis in steps S43, S45, and S46. When the processing data is the embroidery data, the operator actually uses the sewing machine 8 to sew the embroidery pattern according to the embroidery data. When the pattern is sewn correctly, the operator inputs “pass” as the examination result; when the pattern is not sewn correctly, the operator inputs “fail.” Whether the pattern is sewn correctly may include considerations such as whether holes occur in the sewn material, whether puckering is within acceptable limits, and whether sewing time is within allowable limits.

The CPU 31 determines whether a transmission instruction has been detected based on the detection results from the input IF 39 (S202). A transmission instruction is detected when the operator inputs the examination result and selects the key image. Whenno transmission instruction is detected (S202: NO), the CPU 31 waits at S202.

When a transmission instruction is detected (S202: YES), the CPU 31 transmits the examination result entered in the input field to the server 4 via the management page (S103). The CPU 31 then ends the examination process. When multiple application data entries are registered, the CPU 31 may execute transmission of examination results for each entry.

The CPU 41 of the server 4 determines whether the examination result has been received from the third device 3 (S51). When the CPU 41 determines that the examination result has not been received from the third device 3 (S51: NO), processing returns to step S51. When the examination result has been received from the third device 3 (S51: YES), the CPU 41 registers the received examination result in the management page (S52). The CPU 41 then determines whether the examination result is “pass” (S53).

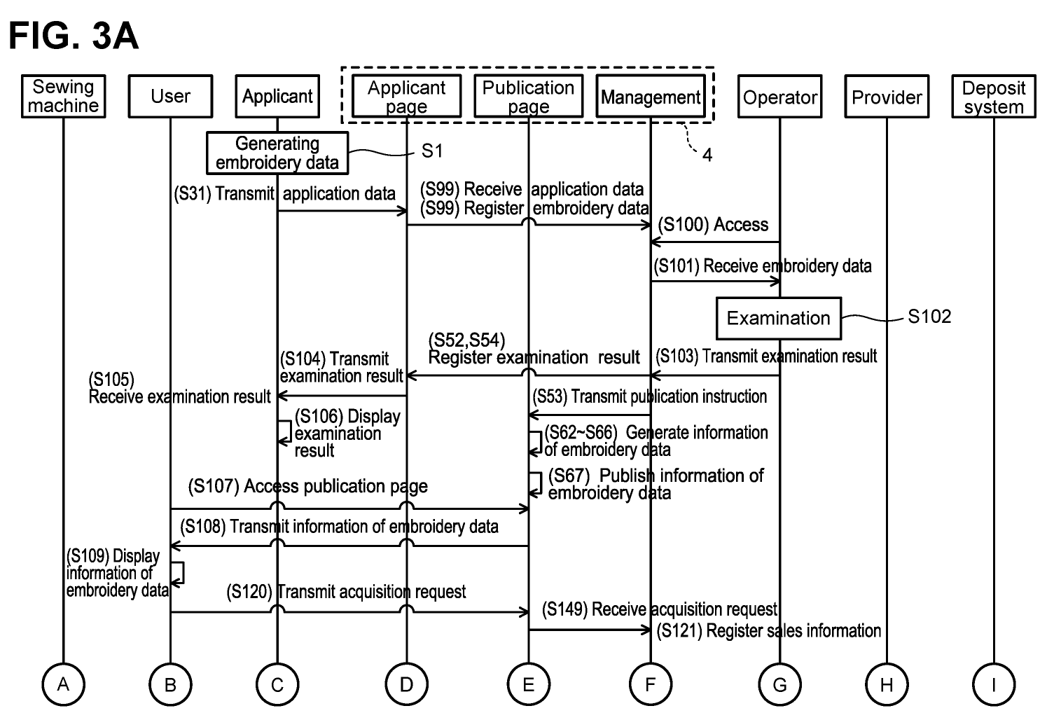

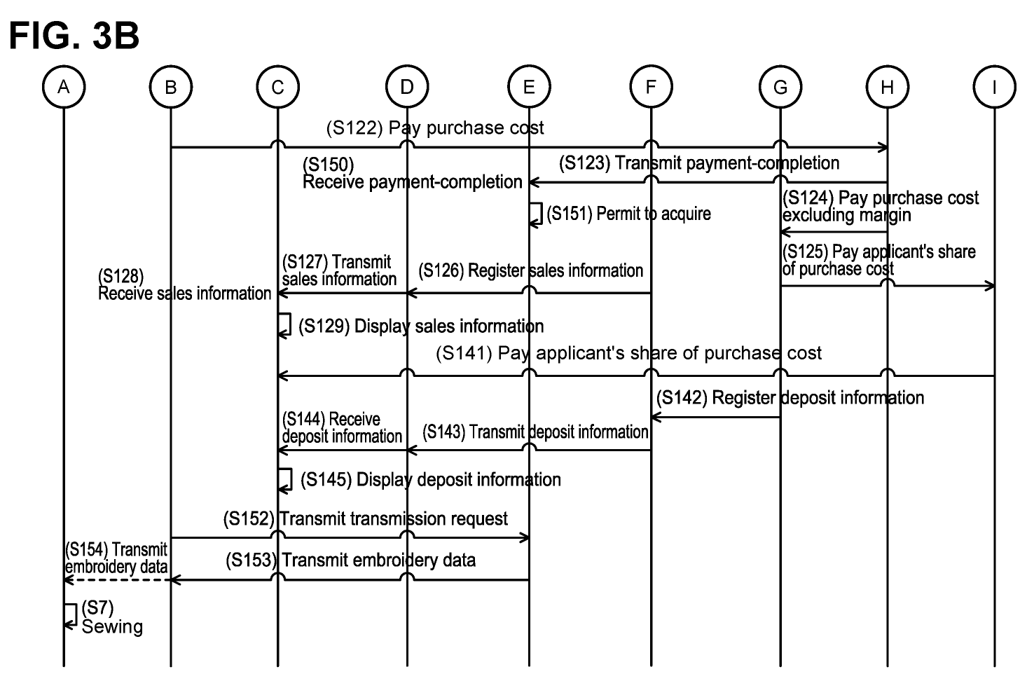

When the examination result is “pass” (S53: YES), the CPU 41 registers information representing the pass determination to the management page associated with the application data (S54) and transmits a publication instruction to the publication page (S55). When the examination result is “fail” (S53: NO), the CPU 41 registers failure information associated with the application data in the management page (S56). After S55 or S56, the CPU 41 ends the processing-data evaluation process. As shown in FIG. 3, when the applicant accesses the application page using the first device 1 and transmits a first disclosure request to the server 4, the server 4 transmits the examination result to the first device 1 (S104). The first disclosure request requests disclosure of the examination result. Step S104 is the examination-result transmission step. When the CPU 11 of the first device 1 receives the examination result (S105), it displays the result on the display 18 (S106).

As shown in FIG. 2, after the processing-data evaluation process, the CPU 41 of the server 4 determines whether the examination result associated with the application data is “pass” or “fail” (S4). When the result is “fail” (S4: NO), the method ends. When the result is “pass” (S4: YES), the CPU 41 starts the processing-data publication process. The CPU 41 executes the processing-data publication process according to instructions in a program stored in the ROM 42 (S5). Parameters necessary for executing the publication process are stored in the memory 44, and data acquired during the process is stored as needed.

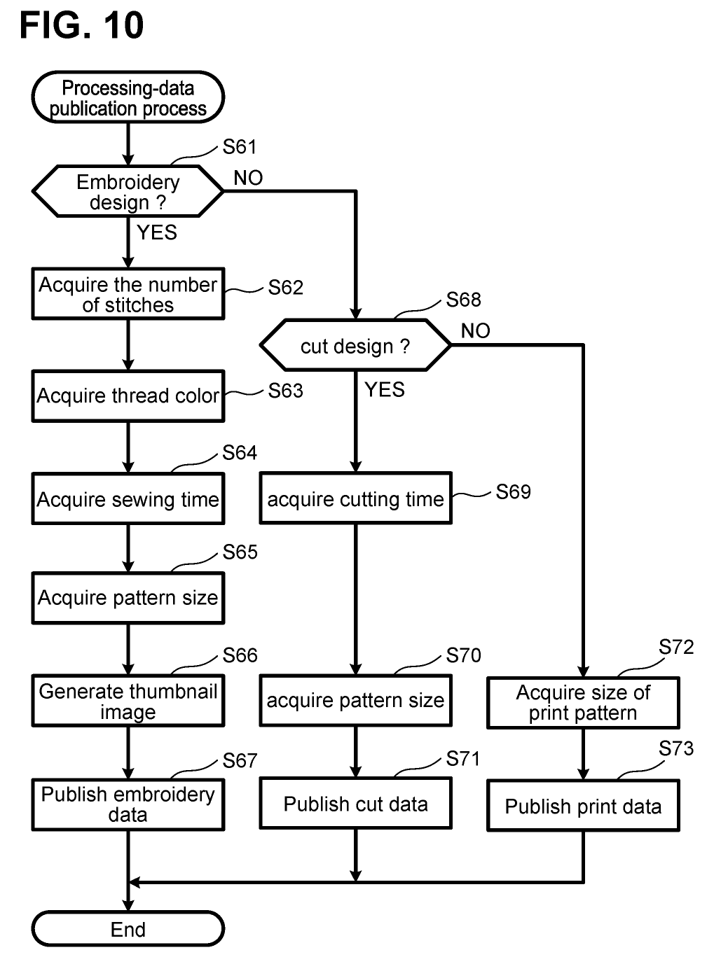

As shown in FIG. 10, in the processing-data publication process, the CPU 41 acquires information indicated by the processing data according to the type of processing data. Specifically, the CPU 41 determines whether the selected data type included in the application data is an embroidery design (S61). When it is an embroidery design (S61: YES), the CPU 41 executes step S62. CPU 41 analyzes the embroidery data to acquire the number of stitches based on the number of needle-drop points (S62).

The CPU 41 analyzes the embroidery data to acquire thread colors based on the thread-color data (S63). Based on the number of stitches acquired in S62 and the number of thread colors in S63, the CPU 41 acquires sewing time (S64). The CPU 41 acquires the pattern size based on the embroidery data (S65). The CPU 41 generates a thumbnail image showing the embroidery pattern based on the embroidery data (S66).

After the examination step S102, the CPU 41 performs a publication step in which the embroidery data is made accessible by the second device 2 (S67). In the publication step, the CPU 41 sets the embroidery data to a state accessible by the second device 2 (S67). The publication step includes setting the embroidery data to be accessible when the embroidery data satisfies predetermined criteria (S67). The CPU 41 controls whether the publication page is public or private by changing permissions of directories or files in the server 4. The publication step includes not making the embroidery data accessible when it does not satisfy predetermined criteria (S56). The predetermined criteria include passing the operator’s examination. “Publication” in this embodiment means at least making the data accessible by the second device 2.

“Publishing embroidery data” includes publishing information indicated by the embroidery data. Such information may include the thumbnail image, for example. Publishing the embroidery data does not necessarily include making the embroidery data itself downloadable by the second device 2. In this embodiment, the CPU 41 publishes information indicated by the processing data (S67), such as the data acquired in steps S62–S66. The publication step publishes the embroidery data on a publication page that is different from the application page, in a state accessible by the second device 2 (S67). In this embodiment, the CPU 41 does not make the embroidery data itself directly downloadable on the publication page.

When the selected data type is not an embroidery design (S61: NO), the CPU 41 determines whether it is a cut design (S68). When the selected data typ is a cut design (S68: YES), the CPU 41 acquires the cutting time required for cutting the cutting pattern based on the cut data (S69). For example, the CPU 41 calculates the cutting time based on the length of cut segments indicated by the cut data. The CPU 41 acquires the pattern size based on the cut data (S70).

The CPU 41 publishes the cut data (S71). Step S71 includes publishing the cut data on a publication page different from the application page in a state accessible by the second device 2. The CPU 41 uses an image represented by the cut data as a thumbnail image. It publishes the thumbnail image, cutting time, and pattern size on the publication page.

When the selected data type is not a cut design (S68: NO), the CPU 41 acquires the size of the print pattern based on the print data (S72). The CPU 41 publishes the print data (S73). Step S73 includes publishing the print data on a publication page different from the application page in a state accessible by the second device 2. The CPU 41 uses the image represented by the print data as the thumbnail image and publishes the thumbnail and pattern size on the publication page. The CPU 41 may also include the print-pattern size on the publication page. After S67, S71, or S73, the CPU 41 ends the processing-data publication process.

As shown in FIG. 2, after the processing-data publication process, the second device 2 of the user executes a purchase process (S6). The purchase process is a process in which the user operates the second device 2 to access the publication page of the server 4 and purchase the processing data published on the publication page.

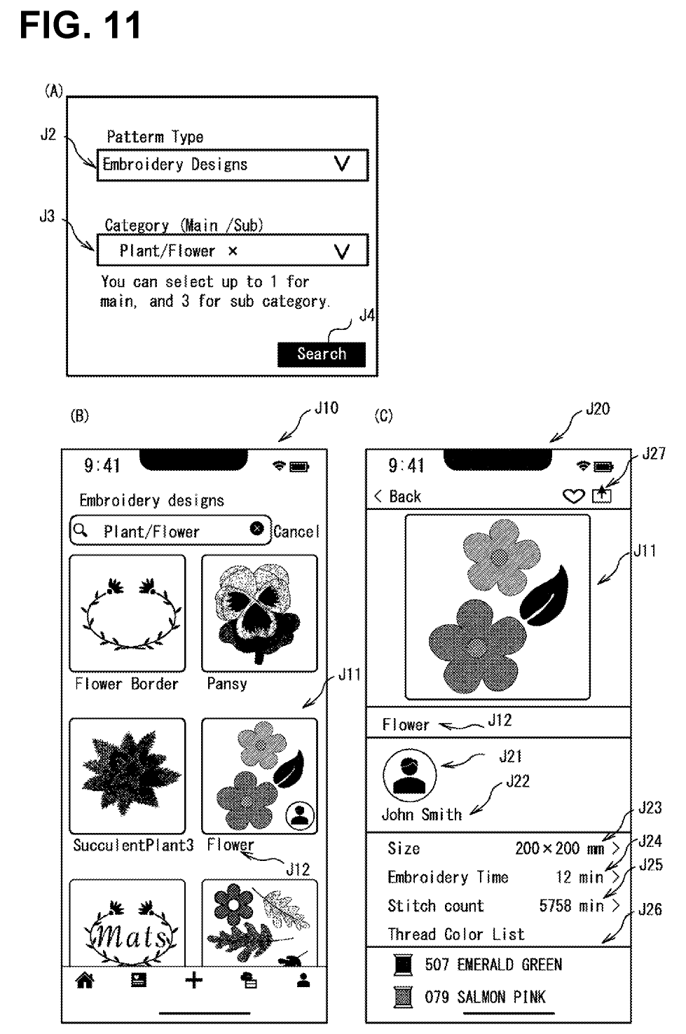

As shown in FIG. 3, the CPU 21 of the second device 2 accesses the publication page (S107). The CPU 41 of the server 4 transmits data to the second device 2 for displaying the publication page on the display 28. Based on the data received from the server 4, the CPU 21 of the second device 2 displays a screen J1, as shown in FIG. 11(A). The screen J1 is a screen for extracting and displaying, on the display 28, information of the processing data published on the publication page, according to the type and category of the selected data.

The screen J1 includes fields J2 and J3, and a key image J4. The field J2 is used to specify the type of selected data. The field J3 is used to specify the category. The key image J4 is selected when transmitting an extraction instruction to the server 4 requesting extraction of processing data registered on the publication page under the conditions indicated in fields J2 and J3. In screen J1, "embroidery design" is selected as the type of selected data.

The user operates the input IF 29 of the second device 2 and selects the key image J4 while the category “Plant/Flower” is selected on screen J1. When the CPU 21 detects selection of key image J4, it transmits an extraction instruction to the server 4. The extraction instruction is a command to extract processing data based on the conditions displayed on screen J1.

The CPU 41 of the server 4 receives the extraction instruction from the second device 2. The CPU 41 extracts, from among the processing data registered on the publication page, the processing data that meets the conditions indicated by the extraction instruction. The CPU 41 then executes a second display step of transmitting to the second device 2 the information of the embroidery data that satisfies the conditions shown on screen J1 (S108). The second display step is a step of displaying, on the second device 2 used by a user different from the applicant, a publication screen that shows the selected data. Through the second display step, the CPU 41 displays, on the second device 2, a publication screen showing selected data of the type designated by the second device 2, and likewise displays selected data of the category designated by the second device 2.

Based on the information transmitted from the server 4, the CPU 21 of the second device 2 displays, on the display 28, a screen J10 including information of embroidery data, as shown in FIG. 11(B) (S109). Screen J10 displays thumbnail images and titles of embroidery data that match the conditions specified by the second device 2. As shown in FIG. 11(B), screen J10 includes a thumbnail image J11 of embroidery data published in step S67, and a title J12. Screen J10 is a screen accessible by the second device 2 when it accesses the publication page.

When the user of the second device 2 selects the thumbnail image J11 on the screen shown in FIG. 11(B), a publication screen J20 showing details of the embroidery data is displayed, as shown in FIG. 11(C). The publication screen J20 includes the thumbnail J11 and the title J12. The publication screen J20 also includes an applicant-representing image J21 and applicant name J22, based on the application contents included in the application data received in S99. The publication screen J20 includes the embroidery-pattern size J23 acquired in S65, the sewing time J24 acquired in S64, the stitch count J25 acquired in S62, and the thread-color list J26 acquired in S63. The publication screen J20 also includes a key image J27 selected when transmitting to the server 4 a request to acquire the processing data displayed.

The user of the second device 2 reviews the contents displayed on the publication screen J20 and selects the key image J27. The CPU 21 of the second device 2 detects selection of the key image J27 based on the output of the input IF 29. The CPU 21 transmits, via the publication page of the server 4, an acquisition request requesting the embroidery data displayed on the publication screen J20 (S120).

When the CPU 41 of the server 4 receives the acquisition request from the second device 2, the CPU 41 registers sales information corresponding to the acquisition request in the management page (S121). The server 4 then transmits settlement data to the second device 2. The settlement data is data for displaying on the display 28 a settlement screen prompting the user to complete the purchase procedure. The settlement processing may alternatively be performed by a provider instead of the server 4. The provider is a platform enabling the second device 2 to access the publication page.

The CPU 21 of the second device 2 displays a payment screen on the display 28 based on the payment data received from the server 4. The user inputs a payment instruction on the payment screen to complete the purchase cost payment. The CPU 21 detects the payment instruction based on the output of the input IF 29. The CPU 21 transmits data for paying the purchase cost to the provider (S122). The payment data includes, for example, the purchase cost and credit-card information. Once step S122 is executed, the purchase cost is paid.

The provider transmits a payment-completion notification to the publication page of the server 4 (S123). The provider pays to the operator the purchase cost excluding the provider’s margin (S124). The operator pays the applicant’s share of the payment into a deposit system that handles payments on behalf of the operator (S125). When the scheduled payment time arrives, the deposit system pays the applicant’s share into a bank account designated by the applicant (S141). The scheduled payment time may be set arbitrarily, for example, at the end of the month. The operator accesses the management page using the third device 3 and registers deposit information in the management page (S142).

In accordance with registration of deposit information in the management page, the CPU 41 of the server 4 registers the deposit information into the application page corresponding to the applicant’s identification information (S143). When the applicant accesses the application page and transmits a second disclosure request to the server 4, the server 4 transmits the registered deposit information to the first device 1 (S144). The second disclosure request requests disclosure of deposit information. Upon receiving the deposit information, the first device 1 displays it on the display 18 (S145).

The CPU 41 of the server 4 registers sales information in the application page when predetermined conditions are satisfied (S126). The predetermined conditions are satisfied when, in step S121, sales information is registered in the management page and, in S151, the second device 2 is permitted to acquire the processing data.

Sales information may be any information related to the fact that processing data included in the application data transmitted by the first device 1 has been purchased. Sales information may include, for example, identification information of the processing data, the date and time of purchase, the purchase amount, and identification information of the purchasing user. The processing-data identification information may be information assigned by the server 4 or information entered by the applicant in the application data, such as the title. Sales information may further include the cumulative number of purchases, total sales amount during a given period, and identification information of purchasing users.

The registered sales information is transmitted from the server 4 to the first device 1 in a predetermined situation (S127). The predetermined situation is when the applicant accesses the application page and transmits a third disclosure request to the server 4. The third disclosure request requests disclosure of sales information. The server 4 transmits the sales information to the first device 1 in a data format displayable on the display 18. Step S127 is the sales-information transmitting step in which sales information indicating that the embroidery data has been purchased is transmitted to the first device 1.

The first device 1 executes a sales-information receiving step of receiving the sales information from the server 4 (S128). In this specific example, the sales-information receiving step receives sales information indicating that the embroidery data has been purchased (S128). The first device 1 receives the sales information in a format displayable on the display 18 and displays it on the display 18 (S129).

The server 4 executes a permission step in accordance with receiving a payment-completion notification from the provider, permitting the second device 2 to acquire the processing data for which payment has been completed (S151). The permission step authorizes a second device 2, which differs from the first device 1, to download the embroidery data via the Internet 5 (S151). In the specific example, the permission step authorizes a user’s second device 2, which differs from both the operator and the applicant, to download the embroidery data (S151).

In the permission step, the CPU 41 permits the second device 2 to download embroidery data when an acquisition request has been received from the second device 2 (S149) and when predetermined conditions are satisfied (S123). The acquisition request requests acquiring embroidery data. The predetermined conditions include satisfying acquisition requirements for embroidery data. The acquisition requirements include completion of payment of the purchase cost for the embroidery data (S150). In the permission step, the CPU 41 permits the second device 2 to download the embroidery data via the Internet 5 from the publication page, which differs from the application page (S151).

After the server 4 permits the second device 2 to acquire the processing data, the user operates the second device 2 and transmits a transmission request to the server 4 via the publication page (S152). The transmission request requests downloading of the purchased processing data. In response to receiving the transmission request from the second device 2, the server 4 transmits the embroidery data specified by the transmission request to the second device 2 (S153). The user then executes a transmission step of transmitting the downloaded processing data from the second device 2 to the processing machine corresponding to the processing data (S154). In the specific example, the second device 2 transmits embroidery data to the sewing machine 8 (S154). When the processing data downloaded from the server 4 is cut data, the second device 2 may transmit the cut data to the cutting machine 9. When the processing data is print data, the second device 2 may transmit the print data to the printer 10.

The processing machine performs the processing operation. The user drives the processing machine to process the workpiece according to the processing data transmitted in step S154. In the specific example, the sewing machine 8 performs a sewing process (S7). The user causes the sewing machine 8 to sew a pattern according to the embroidery data. The sewing process is an example of a processing operation. When the processing data is cut data, the user causes the cutting machine 9 to cut media according to the cut data. When the processing data is print data, the user causes the printer 10 to print an image according to the print data. The system 7 then completes the method of providing processing data. In the above embodiment, the first device 1 is an example of the first device of the present disclosure. The second device 2 is an example of the second device of the present disclosure. The third device 3 is an example of the third device of the present disclosure. The server 4 is an example of the server of the present disclosure. The sewing machine 8 is an example of the sewing machine of the present disclosure. The cutting machine 9 is an example of the cutting machine of the present disclosure. The printer 10 is an example of the printer of the present disclosure. Step S7 is an example of the sewing step of the present disclosure. The application data is an example of the application data of the present disclosure.

Step S99 is an example of the application-receiving step of the present disclosure. The processing of S99 is an example of the application-receiving processing of the present disclosure. Step S151 is an example of the permission step of the present disclosure. The processing of S151 is an example of the permission processing of the present disclosure. Steps S47 and S102 are examples of the examination step of the present disclosure. Step S67 is an example of the publication step of the present disclosure. Step S1 is an example of the generation step of the present disclosure. Step S154 is an example of the transmission step of the present disclosure. Steps S84 and S85 are examples of the type-selection step of the present disclosure. Step S98 is an example of the first display step of the present disclosure.

Step S99 is an example of the upload step of the present disclosure. Step S91 is an example of the category-selection step of the present disclosure. Step S108 is an example of the second display step of the present disclosure. Step S127 is an example of the sales-information transmission step of the present disclosure. Step S128 is an example of the sales-information receiving step of the present disclosure. Step S106 is an example of the examination-result display step of the present disclosure. Step S129 is an example of the third display step of the present disclosure. The processing of S104 is an example of the examination-result transmission processing of the present disclosure.

The method of the above embodiment includes an application-receiving step, an examination step, and a permission step. The application-receiving step is a step of receiving, from the first device 1, application data including embroidery data that causes the sewing machine 8 to sew a pattern (S99). The examination step is a step of examining the embroidery data (S47, S102). The permission step is a step of permitting the download of the embroidery data via the Internet 5 to the second device 2, which is different from the first device 1, after the examination of the embroidery data (S151). The method of the above embodiment contributes to permitting the second device 2, which is different from the first device 1, to download the embroidery data included in the application data received from the first device 1. The method contributes to making the information of the embroidery data available to users after the examination of the embroidery data.

The examination step includes examining whether the embroidery data is to be made accessible by the second device 2. The method includes, after the examination step, a publication step in which the embroidery data is published in a state where it is accessible by the second device 2. Compared to a method in which the examination step does not include examining whether the embroidery data is to be made accessible by the second device 2, the method contributes to improving the suitability of the published embroidery data.

The examination step includes examining the embroidery data by an operator (S102). The application-receiving step includes receiving application data from the first device 1 of an applicant who is different from the operator (S99). The permission step includes permitting the download of the embroidery data to the second device 2 of a user who is different from both the operator and the applicant (S151). The method contributes to the embroidery data included in the application data received from the first device 1 being examined by an operator who is different from the applicant. Compared to a method in which the applicant examines the embroidery data, the method contributes to improving the objectivity of the examination.

The method includes, after the examination step, a publication step in which the embroidery data is published in a state where it is accessible by the second device 2 (S67). The method of the above embodiment contributes to publishing the embroidery data included in the application data received from the first device 1 to the second device 2, which is different from the first device 1. The method contributes to enabling users to view information about the embroidery data.

The application-receiving step includes receiving application data including embroidery data that is in a state not accessible by the second device 2 (S99). The publication step includes, after the examination step, setting the embroidery data to a state accessible by the second device 2 (S67). The method contributes to setting the timing of making the embroidery data included in the application data received from the first device 1 accessible by the second device 2 to a point after the embroidery data has been examined.

The examination step includes examining whether the embroidery data satisfies predetermined criteria (S47, S102). The publication step includes, when the embroidery data satisfies the predetermined criteria, setting the embroidery data to a state accessible by the second device 2 (S67). When the embroidery data does not satisfy the predetermined criteria, the publication step includes not setting the embroidery data to a state accessible by the second device 2 (S56). The publication step of the method contributes to publishing only the embroidery data included in the application data received from the first device 1 that satisfies predetermined criteria. Compared to a method in which all embroidery data included in the application data received from the first device 1 is published, the method contributes to improving the convenience for users of the second device 2 when viewing the published embroidery data.

The predetermined criteria are defined by the operator. Compared to a method in which the predetermined criteria are defined by someone other than the operator, the method contributes to unifying the predetermined criteria.

The permission step includes, in response to receiving an acquisition request from the second device 2 (S149), permitting the download of the embroidery data to the second device 2 when a predetermined condition is satisfied (S123, S151). The acquisition request is a request for acquiring the embroidery data. The predetermined condition is a condition in which the acquisition requirements of the embroidery data are satisfied. Compared to a method in which the download of the embroidery data is permitted unconditionally, the permission step of the method contributes to making it easier for the first device 1 to transmit application data.

The application-receiving step includes receiving application data via an application page (S99). The permission step includes permitting the download of the embroidery data via the Internet 5 from a publication page that is different from the application page to the second device 2 (S151). Compared to a method in which the application page and the publication page are the same page, the method contributes to making it easier for the first device 1 to transmit application data. The permission step of the method contributes to making it easier for users to view published embroidery data via the second device 2.

The application page is a page that the first device 1 can access and the second device 2 cannot access. The publication page is a page that both the first device 1 and the second device 2 can access. The method contributes to preventing the second device 2 from acquiring information about the embroidery data before the embroidery data is examined.

The method includes a sewing step in which the sewing machine 8 stitches a pattern in accordance with the embroidery data (S7). The sewing step of the method contributes to allowing a user of the second device 2, which is different from the first device 1, to operate the sewing machine 8 based on the embroidery data transmitted from the first device 1 to the server 4.

The method includes a transmission step in which embroidery data is transmitted from the second device 2 to the sewing machine 8 (S154). Compared to a method that does not include the transmission step, the transmission step contributes to reducing the labor required for users to store the embroidery data in the sewing machine 8.

The method includes a generation step in which the embroidery data is generated by the applicant (S1). Compared to a method that does not include the generation step, the generation step contributes to clarifying the creator of the embroidery data.

The application-receiving step includes transmitting application data by the first device 1 accessing the application page (S99). The publication step includes publishing the embroidery data in a state accessible by the second device 2 on a publication page that is different from the application page (S67). Compared to a method in which the application page and the publication page are the same page, the method contributes to making it easier for the first device 1 to transmit application data. The permission step of the method contributes to making it easier for users to view published embroidery data via the second device 2.

The examination step includes examining the embroidery data by the third device 3 of the operator accessing a management page that is different from the application page and the publication page (S100, S102). Compared to a method in which the management page is the same as the application page or the publication page, the method contributes to making it easier for the operator to perform the examination.

The acquisition requirements include completion of payment for the purchase cost of the embroidery data (S150). The method includes a sales-information transmission step in which sales information indicating that the embroidery data has been purchased is transmitted to the first device 1 (S127). Compared to a method in which the download of the embroidery data is permitted regardless of whether the payment for the purchase cost is completed, the acquisition requirements of the method contribute to ensuring that the purchase cost is reliably collected from users of the second device 2. The sales-information transmission step of the method contributes to enabling the applicant using the first device 1 to confirm the sales information.

The publication step includes publishing a thumbnail image showing the pattern generated based on the embroidery data (S67). Compared to a method that does not publish a thumbnail image, the publication step of the method contributes to making it easier for users of the second device 2 to understand the appearance of the finished pattern.

The program executed by the server 4 includes instructions for causing the server 4 to execute application-receiving processing, examination-result transmission processing, and permission processing. The application-receiving processing is processing for receiving application data including embroidery data that causes the sewing machine 8 to sew a pattern, from the first device 1 (S99). The examination-result transmission processing is processing for transmitting the result of examining the embroidery data to the first device 1 (S104). The permission processing is processing for permitting, after the examination result is transmitted to the first device 1, the download of the embroidery data via the Internet 5 to the second device 2, which is different from the first device 1 (S151). The program of the above embodiment contributes to permitting the second device 2, which is different from the first device 1, to download the embroidery data included in the application data received from the first device 1. The program contributes to making the information of the embroidery data available to users.

The method includes a first display step, an upload step, and a second display step. The first display step is a step of displaying an application screen on the first device 1 of the applicant (S98). The application screen is a screen for uploading selected data, which is at least one piece of data selected from embroidery data and print data. The embroidery data is data that causes the sewing machine 8 to sew an embroidery pattern. The print data is data that causes the printer 10 to print a print pattern. The upload step is a step of accepting upload of the selected data based on the application screen (S99). The second display step is a step of displaying, on the second device 2 used by a user different from the applicant, a publication screen showing the selected data (S108). The first display step contributes to improving the convenience for the applicant when sending selected data using the first device 1. Compared with a method in which only embroidery data can be included in the application data, the first display step contributes to improving the applicant’s convenience.

The first display step is a step of displaying, on the first device 1 of the applicant, an application screen for uploading selected data, which is at least one piece of data selected from embroidery data, print data, and cut data (S98). The cut data is data that causes the cutting machine 9 to cut a cutting pattern. The first display step contributes to improving the convenience for the applicant when sending selected data using the first device 1. Compared with a method in which cut data cannot be included in the application data, the first display step contributes to improving the applicant’s convenience.

The method further includes, after the upload step, a step of displaying on the first device 1 the examination result of embroidery data (S106). The examination-result display step contributes to allowing the applicant to understand the examination result of the embroidery data.

The method further includes, after the second display step, a third display step of displaying on the first device 1 sales information indicating that embroidery data has been purchased (S129). The third display step contributes to allowing the applicant to understand the sales status of the embroidery data.

The method includes a type-selection step of accepting selection of the type of selected data from among embroidery design, cut design, and print design (S85). The second display step includes displaying, on the second device 2, the publication screen showing the selected data of the type designated by the second device 2 (S108). Compared with a method that does not accept type designation from the second device 2, the second display step contributes to improving convenience for users of the second device 2.

The type-selection step includes accepting selection of the type of selected data based on the file format of the selected data (S84, S85). Compared with a method that accepts type selection regardless of file format, the type-selection step contributes to reducing the possibility of selecting an incorrect type.

The type-selection step includes enabling selection of embroidery design when the file format is the first data format (S19: YES, S20, S84). The type-selection step also includes enabling selection of cut design and print design when the file format is a second data format different from the first data format (S19: NO, S21, S84), and accepting selection of the type (S85). The type-selection step contributes to appropriately setting selectable type options according to the file format of the selected data.

The method includes a category-selection step of accepting selection of a category of the selected data (S91). The second display step includes displaying, on the second device 2, the publication screen showing selected data of the category designated by the second device 2 (S108). Compared with a method that does not accept category designation from the second device 2, the second display step contributes to improving convenience for users of the second device 2.

The category includes a main category and a subcategory associated with the main category. Compared with a method in which categories are not divided into main and subcategories, the category contributes to enabling hierarchical category selection.

The subcategory is selectable when the main category is selected and is not selectable when the main category is not selected. The category contributes to improving the likelihood that the main category and subcategory will be appropriately selected.

The method includes a generation step, an application step, and a sales-information receiving step. The generation step is a step of generating embroidery data that causes the sewing machine 8 to sew a pattern (S1). The application step is a step of transmitting application data including embroidery data to the server 4 (S31). The sales-information receiving step is a step of receiving, from the server 4, sales information indicating that embroidery data has been purchased by a user (S128). The method contributes to receiving sales information related to embroidery data from the server 4. The method contributes to enabling the server 4 to sell embroidery-data information to users, that is, to make the information acquireable by users. The sales-information receiving step contributes to allowing the applicant to understand the sales status of the embroidery data.

The method and program of the present disclosure are not limited to the embodiments described above, and various modifications may be made without departing from the spirit of the disclosure. For example, the following modifications may be made as appropriate. The present disclosure may be executed in various forms, including a non-transitory computer-readable medium storing a program, and system configurations.

Examples of storage media storing the program include “non-transitory tangible media,” such as ROM, tapes, disks, cards, semiconductor memory, programmable logic circuits, and the like. The storage medium may also be RAM used for deploying the program.

The program may be supplied to a computer via any transmissible medium, such as communication networks or broadcast signals. One embodiment of the disclosure may be realized in the form of a data signal embedded in a carrier wave, representing a program transmitted electronically.

(A) The configuration of the system 7 may be modified as appropriate. The system 7 may include or may omit the processing machine. The type of selected data need only include embroidery design. The types and number of selected data may be modified as appropriate. The selected data may include or may omit cut design or print design. The selected data may include plot-design data for a plotter.

The sewing machine 8 may be any machine capable of sewing embroidery patterns, including industrial sewing machines and multi-needle machines having multiple needle bars. There is no particular limitation on the number of needle bars. One processing machine may execute processing for multiple types of selected data. For example, the cutting machine 9 may execute drawing processes as a plotter in addition to cutting operations. The sewing machine 8 may execute cutting operations in addition to sewing embroidery patterns.

The printer 10 may be any type, including an inkjet printer or a label printer.

The configurations of the first device 1 and third device 3 may be modified as appropriate, and may be smartphones, tablets, or other devices. The displays 18, 28, and 38 may be any displays capable of showing images, such as OLED displays, plasma displays, plasma-tube array displays, or electrophoretic electronic paper displays.

The input IFs 19, 29, and 39 may be touch panels, keyboards, mice, switches, joysticks, or other interfaces. Part or all of the embroidery data, cut data, and print data may be transmitted or received via wired or wireless communication between the second device 2 and the server 4. The second device 2 may omit step S154, and data may instead be transferred using a storage medium such as a USB memory.

(B) The programs executed by the server 4 need only be stored in a storage device of the server 4 before being executed by the CPU 41. Thus, the method of acquireing the program, the acquisition path, and the storage device may be modified as appropriate. The program executed by the server 4 may be received from another device via cable or wireless communication and stored in memory. Such other devices may include, for example, PCs or servers connected via a network.

(C) The entities executing each step of the method may be modified as appropriate. The processing executed by the server 4 need not be limited to execution by the CPU 41 and may be executed partially or entirely by other electronic devices, such as ASICs. Similarly, processing by the first device 1, second device 2, and third device 3 may be executed partially or entirely by other electronic devices.

The steps of the method may be distributed across multiple electronic devices, such as multiple CPUs. The order of steps may be changed, and steps may be omitted or added as necessary. The following modifications may also be applied as appropriate.

The method may omit or modify the examination step. The method may perform only step S47 or S102 as the examination step. The examination may be performed by the applicant or by the user. The predetermined criteria may be defined by a third party different from the operator, the applicant, and the user. The examination step may be performed without accessing the management page. The operator may acquire embroidery data from a storage device such as a USB memory and perform the examination. The examination result may be transmitted to the server 4 via the applicant’s first device 1 or the application page.

The method may omit or modify the publication step. The publication step may be executed before the examination step. The publication step may include making embroidery data accessible by the second device 2 even when the data does not meet predetermined criteria. The publication step may include publishing the examination result associated with the embroidery data on the publication page.

The examination result may be represented by an evaluation value. The evaluation value may be numeric or a grade such as Excellent, Good, or Fair. The publication step may include storing embroidery data in an access-permitted storage location of the second device 2. The publication step may omit publishing a thumbnail image. The publication step may use as the thumbnail image either an image uploaded with the application data or a photograph of the embroidery pattern actually sewn during examination. The thumbnail image need not show the entire pattern and may intentionally hide a portion.

The method may omit or modify the second display step. The items displayed on the publication screen may be modified as appropriate. The method may omit accepting type selection or category selection from the second device 2.

The application-receiving step may be modified as appropriate. It may include receiving application data containing embroidery data in a state accessible by the second device 2. It may include receiving application data containing embroidery data without using the application page. The application-receiving step may be executed by the operator’s third device 3.

The permission step may be modified as appropriate. The permission step may permit downloading of embroidery data simply when the second device 2 accesses the publication page, regardless of whether an acquisition request is received. The acquisition requirements may be modified; for example, they need not include completion of purchase payment. The acquisition requirements may include membership in a flat-rate subscription service. They may also include that the number of downloads during the subscription period does not exceed the allowed limit.

The application page may be the same as the publication page. The application page may also be the same as the management page. The application page, publication page, and management page may each be managed by a single server 4 or by multiple servers. That is, different servers may separately handle receiving application data from the first device 1, receiving examination results from the third device 3, and publishing processing data to the second device 2.

The method may omit the sewing step. The method may omit the transmission step. The method may omit the generation step. The generation step may be performed by a person other than the applicant.

The method may omit the sales-information transmitting step. The method may omit the sales-information receiving step. The timing of these steps may be modified as appropriate. These steps may be performed periodically, such as monthly. In the sales-information transmitting step, sales information may be sent from the server 4 directly to the first device 1 without passing through the application page.

The method may omit or modify the first display step. Items and layout displayed on the application screen may be modified as appropriate. The method may allow uploading only embroidery data and may disallow cut data or print data.

The method may omit or modify the type-selection step. The type-selection step may not necessarily select a type based on the file format. The method may not restrict selectable types based on file format.

The method may omit or modify the category-selection step. A category may include only a main category, or may be freely input by the applicant. A subcategory may be selectable regardless of whether a main category is selected. Although the processing performed by the first device 1, second device 2, third device 3, and server 4 targets data, this specification may describe the processing based on the content represented by the data for convenience. For example, “the server 4 transmits sales information to the first device 1” means “the server 4 transmits data representing sales information to the first device 1.”

Examples of content represented by data include acquisition requests, disclosure requests, sales information, and examination results.

While the disclosure has been described in detail with reference to the specific embodiment thereof, this is merely an example, and various changes, arrangements and modifications may be applied therein without departing from the spirit and scope of the disclosure.

What is claimed is:

1. A method comprising:
receiving, from a first device, application data including embroidery data that causes a sewing machine to sew a pattern;
examining the embroidery data; and
permitting, after examining the embroidery data, a second device, which is different from the first device, to download the embroidery data via the Internet.

2. The method according to claim 1,
wherein the examining the embroidery data includes examining whether the embroidery data is to be made accessible by the second device, and
wherein the method further comprises:
publishing the embroidery data in a state accessible by the second device after the examining.

3. The method according to claim 1,
wherein the examining includes examining the embroidery data by an operator;
wherein the receiving the application data includes receiving the application data from the first device of an applicant who is different from the operator; and
wherein the permitting the second device includes permitting the second device of a user who is different from both the operator and the applicant to download the embroidery data.

4. The method according to claim 3, further comprising:
publishing the embroidery data in a state accessible by the second device after examining the embroidery data.

5. The method according to claim 4,
wherein receiving the application data includes receiving application data including the embroidery data in a state inaccessible by the second device, and
wherein the publishing the embroidery data includes, after the examining the embroidery data , setting the embroidery data to a state accessible by the second device.

6. The method according to claim 5,
wherein the examining the embroidery data includes examining whether the embroidery data meets predetermined criteria, and
wherein the publishing the embroidery data includes:
setting the embroidery data to a state accessible by the second device when the embroidery data meets the predetermined criteria; and
not setting the embroidery data to a state accessible by the second device when the embroidery data does not meet the predetermined criteria.

7. The method according to claim 6,
wherein the predetermined criteria are defined by the operator.

8. The method according to claim 1,
wherein the permitting the second device includes, when an acquisition request requesting to acquire the embroidery data is received from the second device and acquisition requirements for the embroidery data are satisfied, permitting the second device to download the embroidery data.

9. The method according to claim 1,
wherein the receiving the application data includes receiving the application data via an application page, and
wherein the permitting the second device includes permitting the second device to download the embroidery data via the Internet from a publication page different from the application page.

10. The method according to claim 9,
wherein the application page is a page accessible by the first device and inaccessible by the second device, and
wherein the publication page is a page accessible by both the first device and the second device.

11. The method according to claim 1, further comprising:
causing a sewing machine to sew the pattern according to the embroidery data.

12. The method according to claim 11, further comprising:
transmitting the embroidery data from the second device to the sewing machine.

13. The method according to claim 3, further comprising:
generating the embroidery data by the applicant.

14. The method according to claim 4,
wherein the receiving the application data includes transmitting the application data by the first device accessing the application page, and
wherein the publishing the embroidery data includes publishing the embroidery data in a state accessible by the second device on a publication page different from the application page.

15. The method according to claim 14,
wherein the examining the embroidery data includes examining the embroidery data by causing a third device of the operator to access a management page different from the application page and the publication page.

16. The method according to claim 8,
wherein the acquisition requirements include completion of payment of the purchase cost for the embroidery data, and
wherein the method further comprising:
transmitting to the first device sales information indicating that the embroidery data has been purchased.

17. The method according to claim 4,
wherein the publishing the embroidery data includes publishing a thumbnail image showing the pattern generated based on the embroidery data.

18. A non-transitory computer readable medium storing computer-readable instructions that, when executed by one or more of processors, cause the one or more of the processors to perform:
receiving, from a first device, application data including embroidery data that causes a sewing machine to sew a pattern;
transmitting, to the first device, a result of examining the embroidery data; and
permitting, after transmitting the result of examining the embroidery data to the first device, a second device different from the first device to download the embroidery data via the Internet.

19. A method comprising:
displaying, at a first device of an applicant, an application screen for uploading selected data that is at least one selected from embroidery data and print data, the embroidery data being data for causing a sewing machine to sew an embroidery pattern, and the print data being data for causing a printer to print a print pattern;
accepting upload of the selected data based on the application screen; and
displaying, at a second device of a user different from the applicant, a publication screen showing the selected data.

20. The method according to claim 19,
wherein displaying at the first device includes displaying, at the first device, an application screen for uploading selected data that is at least one selected from embroidery data, print data, and cut data, the cut data being data for causing a cutting machine to cut a cutting pattern.

21. The method according to claim 19, further comprising:
displaying, at the first device, a result of examining the embroidery data after the upload step.

22. The method according to claim 19, further comprising:
displaying, at the first device, sales information indicating that the embroidery data has been purchased, after the displaying, at the second device, the publication screen.

23. The method according to claim 19, further comprising:
accepting selection of a type of the selected data from among embroidery design, cut design, and print design,
wherein the displaying, at the second device, the publication screen includes displaying, at the second device, the publication screen showing the selected data of the type designated by the second device.

24. The method according to claim 23,
wherein the accepting the selection of the type of the selected data includes accepting selection of the type of the selected data based on a file format of the selected data.

25. The method according to claim 24,
wherein, when the file format is a first data format, the type-selection step enables selection of embroidery design, and when the file format is a second data format different from the first data format, the type-selection step enables selection of cut design and print design.

26. The method according to claim 19, further comprising:
accepting selection of a category of the selected data,
wherein the displaying, at the second device, the publication screen includes displaying, at the second device, the publication screen showing the selected data of the category designated by the second device.

27. The method according to claim 26,
wherein the category includes a main category and a subcategory associated with the main category.

28. The method according to claim 27,
wherein the subcategory is selectable when the main category is selected and is not selectable when the main category is not selected.

29. A method comprising:
generating embroidery data that causes a sewing machine to sew a pattern; transmitting to a server application data including the embroidery data; and
receiving, from the server, sales information indicating that the embroidery data has been purchased by a user.
